(19) United States
(12) Patent Application Publication
(10) Pub. No.: US 2025/0028878 A1
(43) Pub. Date: Jan. 23, 2025

(54) PARALLEL PARTICLE SWARM OPTIMIZATION

(71) Applicant: The Boeing Company, Arlington, VA (US)

(72) Inventors: Ishaan M. Bakhle, Lynnwood, WA (US); Benjamin H. Oster, Wynnewood, PA (US); Justin T. Terek, Philadelphia, PA (US)

(73) Assignee: The Boeing Company, Arlington, VA (US)

(21) Appl. No.: 18/355,144

(22) Filed: Jul. 19, 2023

(51) Int. Cl. G06F 30/25; G06F 30/15

(52) U.S. Cl. CPC G06F 30/25; G06F 30/15

(57) ABSTRACT

A method for parallel particle swarm optimization includes initializing multiple particle positions of multiple particles and multiple particle velocities of the particles in response to multiple design variables, where the particles represent multiple candidate designs within a solution space; parsing the particle positions and the particle velocities into multiple simulation input files in a current iteration of multiple iterations; and presenting the simulation input files in parallel to multiple simulation processors. The method includes simulating, with the simulation processors, the simulation input files in parallel to produce multiple simulation result files; computing multiple objective function values of the particles in response to the simulation result files; updating the particles in the solution space using particle swarm optimization based on the objective function values; and repeating the parsing, the presenting, the simulating, the computing, and the updating in each subsequent iteration of the iterations to identify a final design.

### GOVERNMENT FUNDING

This invention was made with Government support under AMTC 19-08-024 awarded by Department Of Defense. The government has certain rights in this invention.

### TECHNICAL FIELD

The disclosure relates generally to design refinement, and in particular, to a system and/or method for parallel particle swarm optimization.

### BACKGROUND

Current manual processes for optimizing design criteria use manually executed simulations, update design criteria based on engineering judgement, and re-execute the simulations. The steps are subsequently repeated until a desired outcome is achieved. The manual processes are labor intensive.

Accordingly, those skilled in the art continue with research and development efforts in the field of parallel particle swarm optimization of a design.

### SUMMARY

A method for parallel particle swarm optimization is provided herein. The method includes initializing, with a first processor, a plurality of particle positions of a plurality of particles and a plurality of particle velocities of the plurality of particles in response to a plurality of design variables. The plurality of particles represent a plurality of candidate designs within a solution space. The method includes parsing the plurality of particle positions and the plurality of particles velocities into a plurality of simulation input files in a current iteration of a plurality of iterations, presenting the plurality of simulation input files in parallel to a plurality of simulation processors, simulating, with the plurality of simulation processors, the plurality of simulation input files in parallel to produce a plurality of simulation result files, computing a plurality of objective function values of the plurality of particles in response to the plurality of simulation result files, updating the plurality of particles in the solution space using particle swarm optimization based on the plurality of objective function values, and repeating the parsing, the presenting, the simulating, the computing, and the updating in each subsequent iteration of the plurality of iterations to identify a final design.

In one or more embodiments of the method, the updating includes calculating a plurality of particle best positions of the plurality of particles in response to the plurality of objective function values at an end of the current iteration; calculating a global best position of the plurality of particles in response to the plurality of objective function values at the end of the current iteration, and updating the plurality of particles velocities at the end of the current iteration in response to the plurality of particles velocities at a start of the current iteration, the plurality of particle best positions and the global best position.

In one or more embodiments of the method, the updating of the plurality of particles velocities is in further response to a plurality of weights, a plurality of cognitive coefficients, and a plurality of social coefficients that correspond to the plurality of particles.

In one or more embodiments of the method, the updating includes calculating a plurality of normalized updated particle velocities with respect to a plurality of design variable boundaries at the end of the current iteration, and updating the plurality of particle positions at the end of the current iteration in response to the plurality of particle positions at the start of the current iteration and plurality of normalized updated particle velocities.

In one or more embodiments of the method, the parsing includes converting a plurality of design variables into a plurality of simulation variables for a current particle of the plurality of particles, and adding the plurality of simulation variables of the current particle to a simulation runner object array.

In one or more embodiments of the method, the parsing further includes repeating the converting and the adding for each subsequent particle of the plurality of particles, and separating the simulation runner object array into the plurality of simulation input files after the simulation runner object array is populated.

In one or more embodiments of the method, the computing includes selecting from the plurality of simulation result files a plurality of data items that correspond to a current particle of the plurality of particles, computing an objective function value of the current particle in response to the plurality of data items that correspond to the current particle, and storing the objective function value in an objective function value array.

In one or more embodiments of the method, the computing further includes repeating the selecting and the computing for each subsequent particle of the plurality of particles, and storing the objective function value of each of the plurality of particles in a current iteration in an objective function history matrix.

In one or more embodiments of the method, the final design feeds one or more downstream calculations that form part of a vehicle.

In one or more embodiments of the method, the initializing includes defining a plurality of design variable boundaries, initializing a position matrix of the plurality of particle positions within the plurality of design variable boundaries, defining a plurality of initial velocity bounds, and initializing a velocity matrix of the plurality of particles velocities within the plurality of initial velocity bounds.

A system for parallel particle swarm optimization is provided herein. The system includes a plurality of simulation processors and a first processor. The plurality of simulation processors are operational to simulate a plurality of simulation input files in parallel to produce a plurality of simulation result files. The first processor is operational to initialize a plurality of particle positions of a plurality of particles and a plurality of particles velocities of the plurality of particles in response to a plurality of design variables. The plurality of particles represent a plurality of candidate designs within a solution space. The first processor is further operational to parse the plurality of particle positions and the plurality of particles velocities into the plurality of simulation input files in a current iteration of a plurality of iterations, present the plurality of simulation input files in parallel to the plurality of simulation processors, compute a plurality of objective function values of the plurality of particles in response to a plurality of simulation result files, update the plurality of particles in the solution space using particle swarm optimization based on the plurality of objective function values, and repeat the parse, the present, the compute, and the update in each subsequent iteration of the plurality of iterations to identify a final design.

In one or more embodiments of the system, the update includes to calculate a plurality of particle best positions of the plurality of particles in response to the plurality of objective function values at an end of the current iteration, calculate a global best position of the plurality of particles in response to the plurality of objective function values at the end of the current iteration, and update the plurality of particles velocities at the end of the current iteration in response to the plurality of particles velocities at a start of the current iteration, the plurality of particle best positions and the global best position.

In one or more embodiments of the system, the update of the plurality of particles velocities is in further response to a plurality of weights, a plurality of cognitive coefficients, and a plurality of social coefficients that correspond to the plurality of particles.

In one or more embodiments of the system, the update further includes to calculate a plurality of normalized updated particle velocities with respect to a plurality of design variable boundaries at the end of the current iteration, and update the plurality of particle positions at the end of the current iteration in response to the plurality of particle positions at the start of the current iteration and plurality of normalized updated particle velocities.

In one or more embodiments of the system, the parse includes to convert a plurality of design variables into a plurality of simulation variables for a current particle of the plurality of particles, and add the plurality of simulation variables of the current particle to a simulation runner object array.

In one or more embodiments of the system, the parse further includes to repeat the convert and the add for each subsequent particle of the plurality of particles, and separate the simulation runner object array into the plurality of simulation input files after the simulation runner object array is populated.

In one or more embodiments of the system, the compute includes to select from the plurality of simulation result files a plurality of data items that correspond to a current particle of the plurality of particles, compute an objective function value of the current particle in response to the plurality of data items that correspond to the current particle, and store the objective function value in an objective function value array.

In one or more embodiments of the system, the compute further includes to repeat the select and the compute for each subsequent particle of the plurality of particles, and store the objective function value of each of the plurality of particles in a current iteration in an objective function history matrix.

In one or more embodiments of the system, the final design feeds one or more downstream calculations that form part of a vehicle.

A non-transitory computer readable storage medium storing instructions that control data processing is provided herein. The instructions, when executed by a processor cause the processor to perform a plurality of operations including initializing a plurality of particle positions of a plurality of particles and a plurality of particles velocities of the plurality of particles in response to a plurality of design variables. The plurality of particles represent a plurality of candidate designs within a solution space. The operations further include parsing the plurality of particle positions and the plurality of particles velocities into a plurality of simulation input files in a current iteration of a plurality of iterations, presenting the plurality of simulation input files in parallel to a plurality of simulation processors, wherein the plurality of simulation processors simulate the plurality of simulation input files in parallel to produce a plurality of simulation result files, computing a plurality of objective function values of the plurality of particles in response to the plurality of simulation result files, updating the plurality of particles in the solution space using particle swarm optimization based on the plurality of objective function values, and repeating the parsing, the presenting, the computing, and the updating in each subsequent iteration of the plurality of iterations to identify a final design.

The above features and advantages, and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a graph of a method for multi-step particle swarm optimization in accordance with one or more exemplary embodiments.

FIG. 2 is a functional flow diagram for design variables conversions to simulation inputs in accordance with one or more exemplary embodiments.

FIG. 3 is a functional flow diagram for objective function evaluations in accordance with one or more exemplary embodiments.

FIG. 4 is a table of particle best values and global best value evaluations in accordance with one or more exemplary embodiments.

FIG. 5 is an equation of a particle velocity update in accordance with one or more exemplary embodiments.

FIG. 6 is an equation of a calculation of a normalized updated particle velocity in accordance with one or more exemplary embodiments.

FIG. 7 is an equation of a particle position update in accordance with one or more exemplary embodiments.

FIG. 8 is a graph of multiple particle swarm optimization iterative approaches in accordance with one or more exemplary embodiments.

FIGS. 9A and 9B are a functional flow diagram of a system for parallel particle swarm optimization in accordance with one or more exemplary embodiments.

FIG. 10 is a flow diagram of a detailed method for initialization of the particle positions and the particle velocities in accordance with one or more exemplary embodiments.

FIG. 11 is a flow diagram of a detailed method for distributing particle positions and particle velocities among simulation input files in accordance with one or more exemplary embodiments.

FIG. 12 is a flow diagram of a detailed method for computation of the objective function values and storing the objective function values in an objective function history matrix in accordance with one or more exemplary embodiments.

FIG. 13 is a schematic block diagram of a computer in accordance with one or more exemplary embodiments.

FIG. 14 is a schematic diagram of components of a vehicle in accordance with one or more exemplary embodiments.

### DETAILED DESCRIPTION

Embodiments of the present disclosure include a method and/or a system for parallel particle swarm optimization of designs. The particle swarm optimization technique is used to maximize exploration of a solution space of a design in parallel, rather than through sequential iterations. Parameters within the optimization are specifically tuned to reduce the wall time suitable to perform optimizations within high-fidelity simulations that are capable of parallel execution with expensive-to-evaluate cost functions. The method and/or system are applicable to high-fidelity engineering simulation (e.g., a flight dynamics simulation).

Particle swarm optimization is a technique that optimizes a problem by iteratively improving candidate solutions (or particles) with regards to a measure of quality. The particles are moved in a solution space based on particle positions and particle velocities. Movement of the individual particles is influenced by a local best known position, and is also guided toward best known positions in the search space. The best known positions are updated as better positions are found by other particles. The technique generally moves the particles in a swarm graph toward a final best solution of a final design.

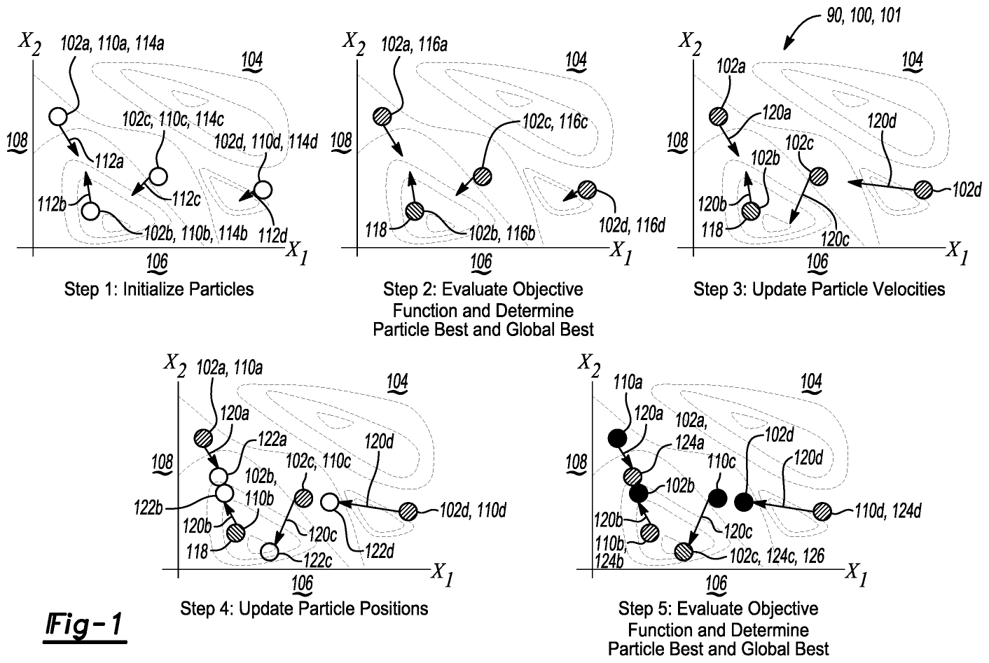

Referring to FIG. 1, a graph 90 of an example method 100 for multi-step particle swarm optimization 101 is shown in accordance with one or more exemplary embodiments. The method 100 (or process) generally include several (e.g., five) steps, labeled Step 1 to Step 5 in the figure. In step 1, multiple (e.g., four) particles 102a-102d are initialized in a solution space 104. The solution space 104 may have multiple dimensions, for example a first dimension 106 (e.g., X₁) and a second dimension 108 (e.g., X₂), as illustrated. Each particle 102a-102d has a respective initial particle position 110a-110d and a respective initial particle velocity 112a-112d. The particles 102a-102d represent multiple candidate designs 114a-114d in the solution space 104. The contour lines illustrate various example objective function evaluation levels.

In step 2, the process evaluates an objective function and determines particle best values 116a-116d and a global best value 118. In step 3, the particle velocities 112a-112d are updated to updated particle velocities 120a-120d based on the particle best values 116a-116d and the global best values 118. In step 4, the particle positions 110a-110d are updated to updated particle positions 122a-122d in response to the updated particle velocities 120a-120d. In step 5, the process evaluates the objective functions and determines updated particle best values 124a-124d and an updated global best value 126 of the particles 102a-102d. One or more iterations round step 3, step 4 and step 5 are subsequently performed. Step 3 updates the particle velocities, step 4 updates the particle positions, and step 5 determines the particle best values and the global best value after a fixed number of iterations. In various embodiments, a stopping criteria based on design variable values or objective function values may be used to end the iterations. After the final iteration, a final design is identified as the final global particle best value in the solution space 104.

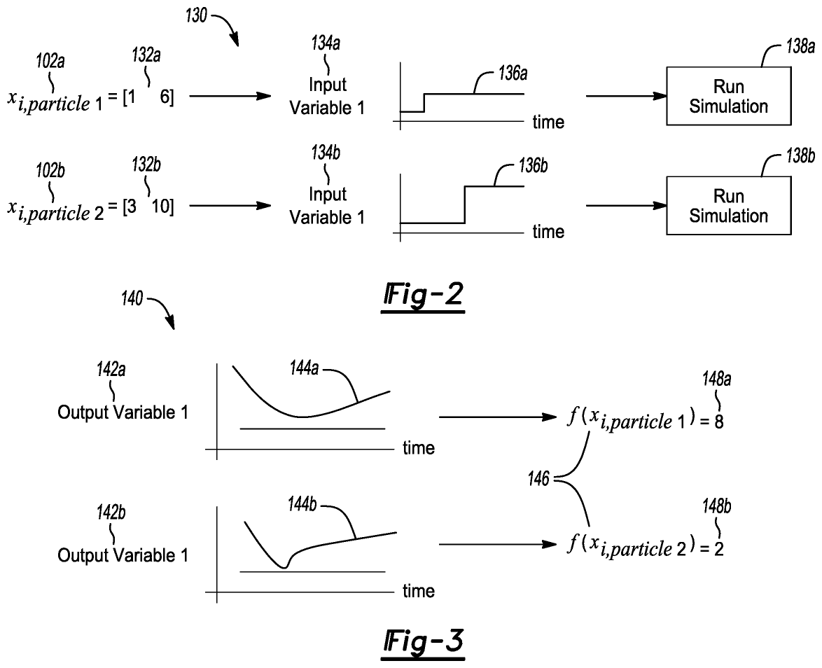

Referring to FIG. 2, with reference back to FIG. 1, a functional flow diagram 130 of an example flow for design variables conversions to simulation inputs is shown in accordance with one or more exemplary embodiments. The example uses the particles 102a-102b and is applicable to the other particles 102c-102d. Design variables 132a-132b (e.g., X_{i,particle j}, where i=1 to m iterations and j=1 to n particles) are associated with each particle 102a-102b. The design variables 132a-132b act as input variables 134a-134b that change 136a-136b in time. In various embodiments, the input variables 134a-134b may be time invariant. The input variables 134a-134b are subsequently presented to simulations 138a-138b for parallel evaluation.

Referring to FIG. 3, with reference back to FIGS. 1 and 2, a functional flow diagram 140 of an example flow for objective function evaluations is shown in accordance with one or more exemplary embodiments. The example uses the particles 102a-102b and is applicable to the other particles 102c-102d. Output variables 142a-142b that are received from the simulations 138a-138b change 144a-144b in time. In various embodiments, the output variables 142a-142b may be time invariant. The output variables 142a-142b are entered into the objective function 146 to produce respective objective function values 148a-148b for the particles 102a-102b at iteration i.

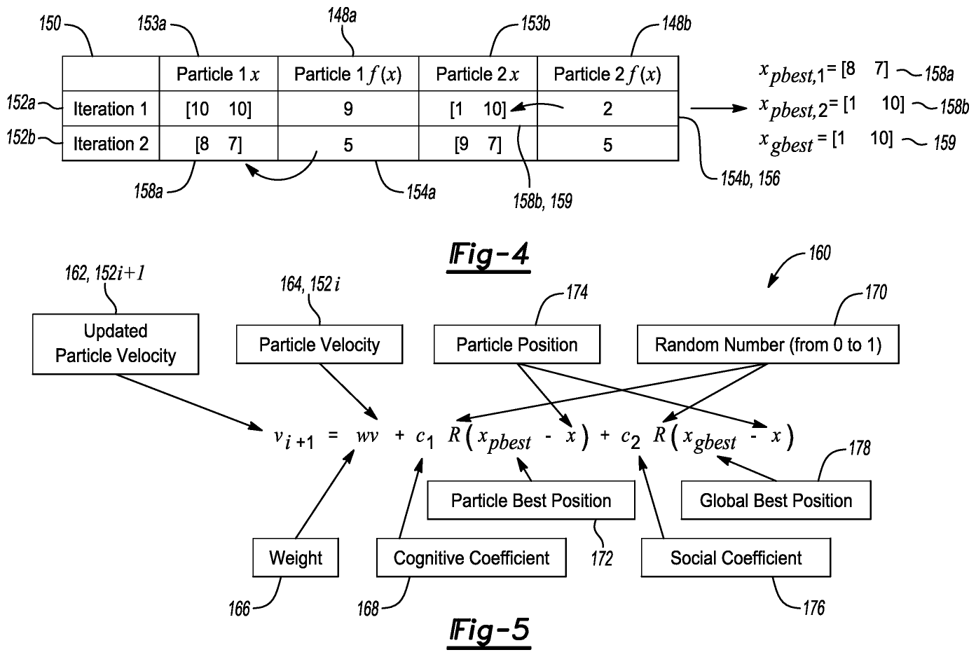

Referring to FIG. 4, with reference back to FIGS. 1 to 3, a table 150 of example particle best values and global best value evaluations is shown in accordance with one or more exemplary embodiments. The example uses the particles 102a-102b and is applicable to the other particles 102c-102d. After initialization, the particles 102a-102b are subjected to multiple (e.g., two in the illustration) iterations 152a-152b. Each iteration 152a-152b calculates the objective function value 148a at a particle position 153a for particle 102a, and a particle objective function value 148b at a particle position 153b for particle 102b. The objective function value 148a for the particle 102a among the iterations 152a-152b identifies a final particle best value 154a (e.g., the lowest value) for the particle 102a at the end of the iterations. The objective function value 148b for the particle 102b among the iterations 152a-152b identifies a final particle best value 154b (e.g., the lowest value) for the particle 102b at the end of the iterations. Among the final particle best values 154a-154b, the final particle best value 154b for the particle 102b is better (e.g., lower) than the final particle best value 154a for the particle 102a and so is considered the global best value 156.

The final particle best value 154a is associated with a final particle best position 158a of the particle 102a at the end of a second iteration 152b. The final particle best value 154b is associated with a final particle best position 158b of the particle 102b at the end of the first iteration 152a. Therefore, the final particle best position 158a of the particle 102a is [8,7] in the example. The final particle best position 158b of the particle 102b is [1,10] in the example. The global best value 156 matches the final particle best value 154b of the particle 102b and so a global best position 159 is also [1,10] in the example.

Referring to FIG. 5, with reference back to FIGS. 1 to 4, an equation 160 of an example particle velocity update is shown in accordance with one or more exemplary embodiments. The example uses particle 102a and is applicable to the other particles 102b-102d. An updated particle velocity 162 for the particle 102a in a next iteration 152ᵢ₊₁ is calculated as function of the particle velocity 164 of the particle 102a in a current iteration 152₁, a weight 166, a cognitive coefficient 168, a random number 170 (e.g., from 0 to 1), a particle best position 172 of the particle 102a, a particle position 174 of the particle 102a, a social coefficient 176, and a global best position 178.

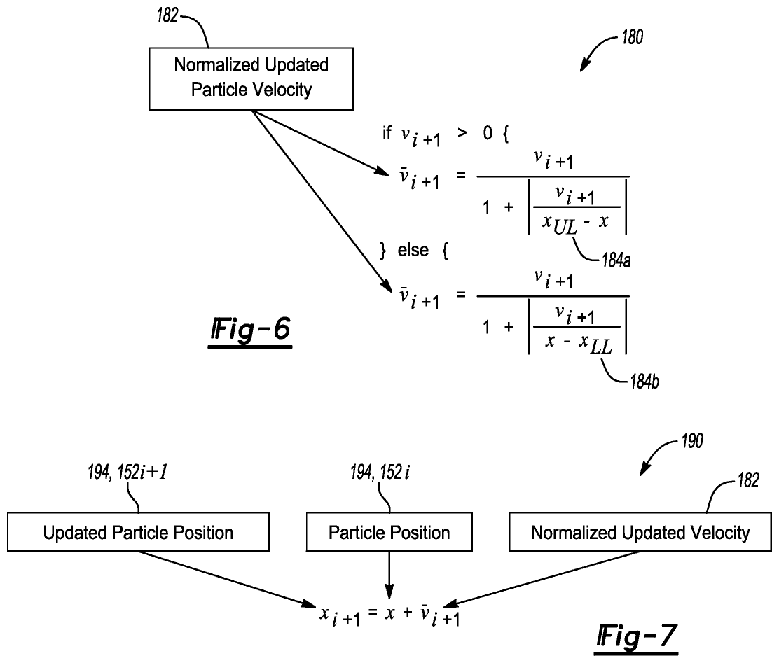

Referring to FIG. 6, with references back to FIGS. 1 to 5, an equation of an example calculation 180 of a normalized updated particle velocity 182 is shown in accordance with one or more exemplary embodiments. The example uses particle 102a and is applicable to the other particles 102b-102d. The updated particle velocity 162 may be normalized so that the particle 102a does not exceed design variable boundaries 184a-184b. An example hyperbolic approach for calculating the normalized updated particle velocity 182 (v̅ᵢ₊₁) is illustrated in the figure, where 184a (X_{UL}) is an upper boundary limit and 184b (X_{LL}) is a lower boundary limit.

Referring to FIG. 7, with reference back to FIGS. 1 to 6, an example equation 190 of a particle position update is shown in accordance with one or more exemplary embodiments. The example uses particle 102a and is applicable to the other particles 102b-102d. An updated particle position 192 (xᵢ₊₁) for the particle 102a in the next iteration 152ᵢ₊₁ is calculated as function of the particle position 194 (x) of the particle 102a in the current iteration 152₁, and the normalized updated particle velocity 182 (v̅ᵢ₊₁).

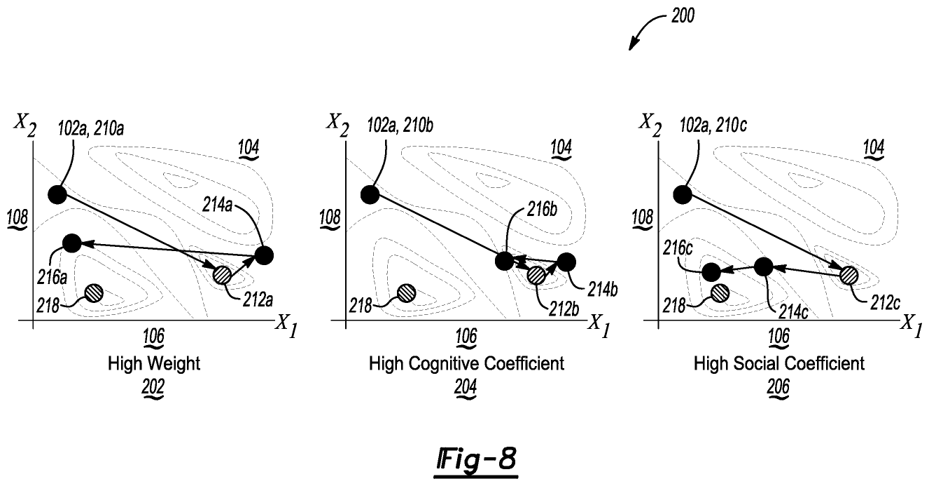

Referring to FIG. 8, with references back to FIGS. 1 to 7, a graph 200 of an example multiple particle swarm optimization iterative approach is shown in accordance with one or more exemplary embodiments. The graph 200 generally illustrate several (e.g., three) approaches 202, 204, and 206 for different optimizations. The example uses particle 102a and is applicable to the other particles 102b-102d. The solution space 104 illustrated for each approach 202, 204, and 206 has the first dimension 106 and the second dimension 108.

The approach 202 may be a high particle weight approach. The weight 166 determines how much the particle 102a may continue on a self-path and explore the solution space 104. The approach 204 may be a high cognitive coefficient approach. The cognitive coefficient 168 determines how much the particle 102a may move towards an own best known solution. The approach 206 may be a high social coefficient approach. The social coefficient 176 determines how much the particle 102a may move towards the global best known solution.

A number of the particles 102a-102d and/or a number of the iterations 152a-152b is selected based on the problem being solved. A sufficient number of particles 102a-102d are employed to thoroughly explore the solution space 104. Generally, more design variables 132a-132b result in the use of more particles 102a-102d. The optimization may be tuned to involve as few iterations 152a-152b as practical to reduce the wall time of running the simulations 138a-138b.

For each iteration 152a-152b, the simulations 138a-138b for the particles 102a-102d are run in parallel on a computing platform having multiple computers (or processors) in one or more exemplary embodiments. A high number of particles 102a-102d, high-valued cognitive coefficients 168, high-valued social coefficients 176, and few iterations 152a-152b may be used for improved performance by promoting faster convergence.

In the high particle weight approach 202, the particle position 210a of the particle 102a initially moves through the solution space 104 toward an own particle best position 212a. In subsequent iterations, the particle 102a moves to particle positions 214a and 216a. The particle 102a may not move toward the own particle best position 212a or a global best position 218.

In the high cognitive coefficient approach 204, the particle position 210b of the particle 102a initially moves through the solution space 104 toward an own particle best position 212b. In subsequent iterations, the particle 102a moves from the own particle best position 212b to particle positions 214b and 216b. The particle 102a eventually moves toward the global best position 218.

In the high social coefficient approach 206, the particle position 210c of the particle 102a initially moves through the solution space 104 toward an own particle best position 212c. In subsequent iterations, the particle 102a moves to particle positions 214c and 216c. The particle 102a eventually moves toward the global best position 218.

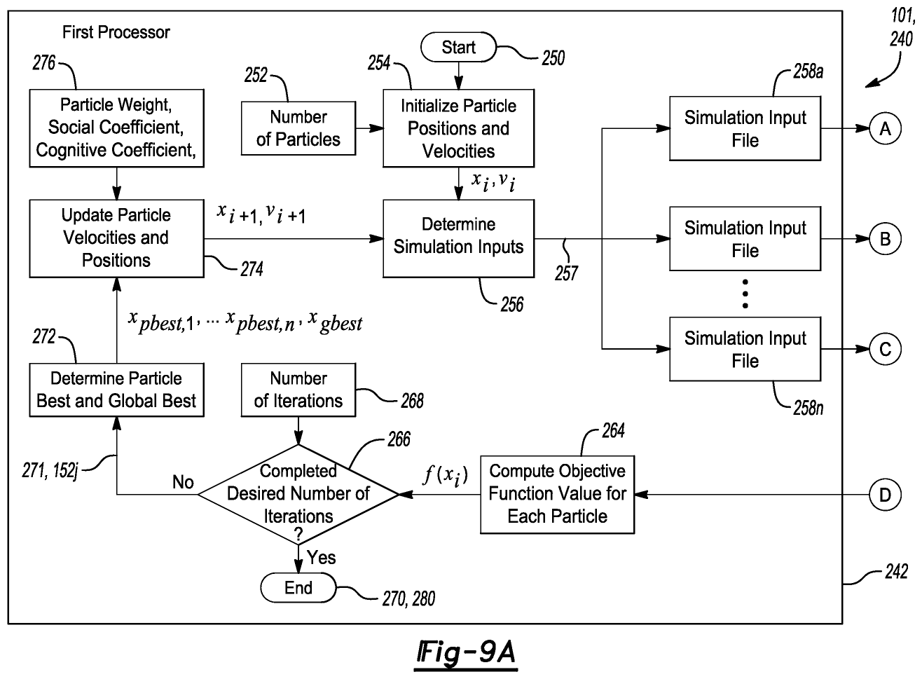

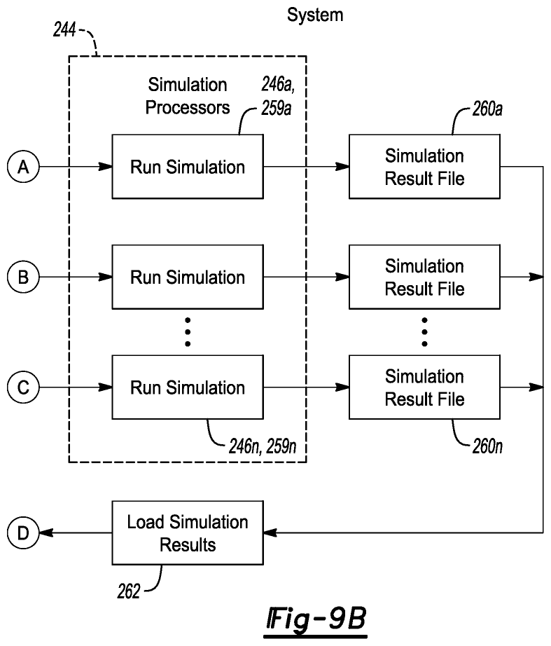

Referring to FIGS. 9 and 9B, with reference back to FIGS. 1 and 8, a functional flow diagram of an example system 240 for parallel particle swarm optimization is shown in accordance with one or more exemplary embodiments. The system 240 generally includes one or more first processors 242 (one shown) and a computing platform 244. The computing platform 244 has multiple simulation processors 246a-246n organized for parallel execution. The system 240 is operational to perform the particle swarm optimization 101.

The first processor 242 is operational to start 250 the particle swarm optimization 101. For a number of particles 252 (e.g., 102a-102d) and design variables selected for the process, an initialization 254 is performed to establish the initial particle positions 110a-110b (Xᵢ) and the initials particle velocities 112a-112d (Vᵢ). The number of particles represent a number of candidate designs 114a-114d within the solution space 104. The first processor 242 parses (or separates) 256 the initial particle positions 110a-110b and the initial particle velocities 112a-112d into multiple simulation input files 258a-258n in a current iteration of several iterations. The simulation input files 258a-258n are presented 257 in parallel from the first processor 242 to the simulation processors 246a-246n where the simulations 259a-259n are run on the candidate designs 114a-114d. The simulation processors 246a-246n generate simulation result files 260a-260n by exercising the simulation input files 258a-258n. When the simulations 259a-259n end, the simulation result files 260a-260n are loaded 262 back to the first processor 242.

The first processor 242 is further operational to compute 264 the objective function values 148a-148b (e.g., f(Xᵢ)) of the particles 102a-102d in response to the simulation result files 260a-260n. A check 266 is performed to determine if the intended number of iterations 268, or some other stopping criteria, has been met. If the iterations are complete (Yes), the particle swarm optimization 101 is ended 270. If more iterations may be run (No), the first processor 242 determines (or calculates) 272 the particle best values 116a-116d (e.g., X_{pbest,1}, . . . ,X_{pbest,n}) and the global best values 118 (e.g., X_{gbest}) based on the objective function values 148a-148b (e.g., f(Xᵢ)).

At a start of repeating 271 a loop in a subsequent iteration 152j, the first processor 242 uses the particle best values 116a-116d (e.g., X_{pbest,1}, . . . ,X_{pbest,n}) and the global best values 118 (e.g., X_{gbest}) from the calculation 272, along with the weights 166, social coefficients 176, and cognitive coefficients 168 provided as user inputs 276 to update 274 the particle velocities 112a-112d and the particle positions 110a-110d to the updated particle velocities 120a-120d (e.g. Vᵢ₊₁) and the updated particle positions 122a-122d (e.g., Xᵢ₊₁). The updated particle velocities 120a-120d and the updated particle positions 122a-122d are again parsed 256 into the simulation input files 258a-258n, presented 257 to the simulation processors 246a-246n, simulated 259a-259n, loaded 262 back into the first processor 242, the objective functions values 148a-148b are computed 264 again, and the stopping criteria is checked 266 again. If the stopping criteria is still not satisfied, the repeating 271 may continue with the calculating 272 of the particle best values 116a-116d and the global best value 118, and updating 274 of the particle velocities and the particle positions for the next loop. Once the stopping criteria is satisfied, the (final) global best position 218 may identify a final design 280 in the solution space 104. The final design 280 may feed one or more downstream calculations that may form part of a vehicle or influence some other design.

Referring to FIG. 10, with references back to FIGS. 1-9B, a flow diagram of an example detailed method 290 for the initialization 254 of the particle positions and the particle velocities is shown in accordance with one or more exemplary embodiments. The method 290 includes steps 292 to 302, as illustrated. The sequence of steps is shown as a representative example. Other step orders may be implemented to meet the criteria of a particular application.

The initialization 254 starts in the step 292. In the step 294, optimization design variable boundaries 304 (e.g., X_{lower}, Xᵤₚₚₑᵣ) are defined. A position matrix 306 of the particle positions 110a-110d may be initialized (randomly or non-randomly) within the plurality of design variable boundaries 184a-184b in the step 296 based on the number of particles 252. For example, a matrix X=(X_{lower}+0.01)+((Xᵤₚₚₑᵣ−0.01)−(X_{lower}+0.01))R, where the matrix X is a (number of design variables)-by-(number of particles) matrix, and the matrix R has the same dimensions as the matrix X and is populated with random numbers from 0-1.

Initial velocity bounds 308 (e.g., V_{lower}, Vᵤₚₚₑᵣ) may be defined in the step 298. A velocity matrix 310 of the particles velocities 112a-112d within the plurality of initial velocity bounds 308 is initialized (randomly or non-randomly) in the step 300. For example, a velocity matrix V=V_{lower}+(Vᵤₚₚₑᵣ−V_{lower})R, where the matrix V is a (number of design variables)-by-(number of particles) matrix, and the matrix R has the same dimensions as the matrix V and is populated with random numbers from 0-1. The initialization 254 ends in the step 302.

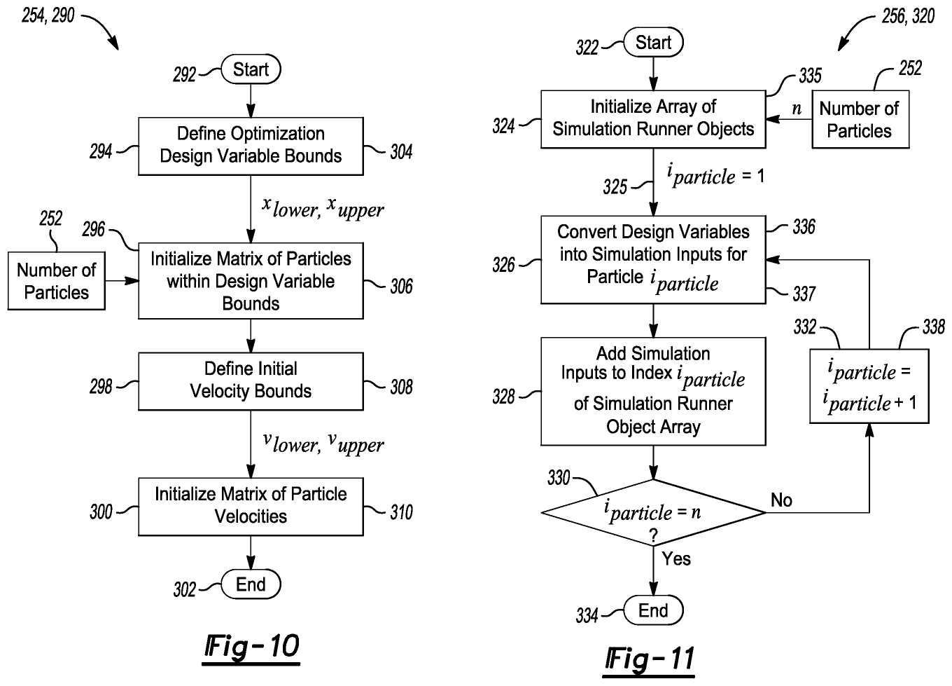

Referring to FIG. 11, with references back to FIGS. 1-9B, a flow diagram of an example detailed method 320 for the parsing 256 of the particle positions and the particle velocities among the simulation input files 258a-258n is shown in accordance with one or more exemplary embodiments. The method 320 includes steps 322 to 332, as illustrated. The sequence of steps is shown as a representative example. Other step orders may be implemented to meet the criteria of a particular application.

The parsing 256 may begin at the step 322. In the step 324, a simulation runner object array 335 may be initialized (e.g., current particle 325, index i_{particle}=1) based on the number of particles 252. The simulation runner object array 335 may be a (one)-by-(number of particles) matrix. In the step 326, multiple design variables 336 may be converted into simulation variables 337 for each particle. Simulation inputs may be added at the index i_{particle} of the simulation runner object array 335 in the step 328. A check is made in the step 330 to determine if each particle has been considered and the simulation runner object array 335 is populated. If more particles may be considered (No), the index i_{particle} may be incremented to a subsequent particle 338 in the step 332 and the method 320 returns to the convert step 326. After each particle has been considered (Yes), the method 320 ends in the step 334.

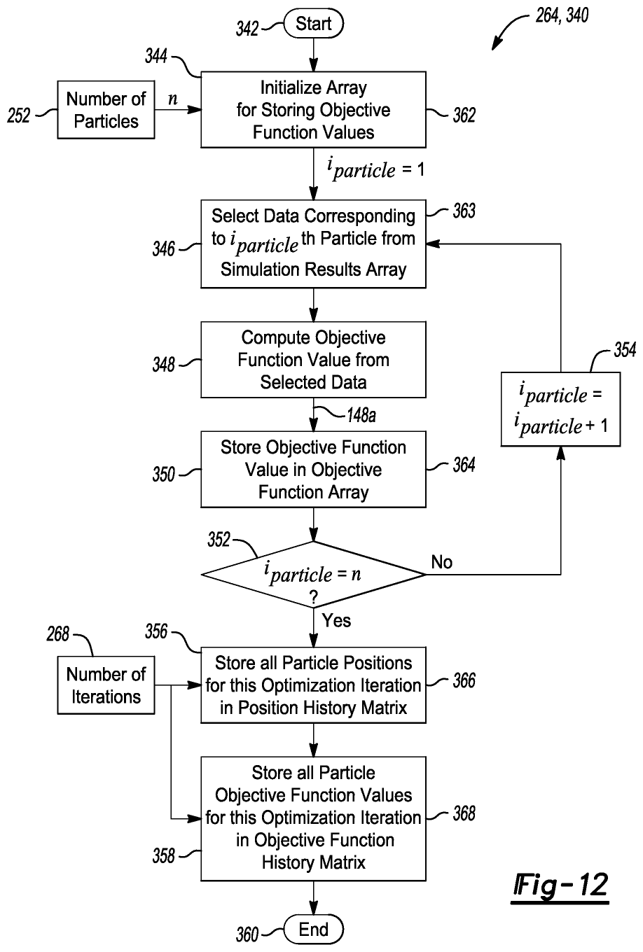

Referring to FIG. 12, with references back to FIGS. 1-9B, a flow diagram of an example detailed method 340 for the computation 264 of the objective function values and storing the objective function values in an objective function history matrix is shown in accordance with one or more exemplary embodiments. The method 340 includes steps 342 to 360, as illustrated. The sequence of steps is shown as a representative example. Other step orders may be implemented to meet the criteria of a particular application.

The computation 264 starts in the step 342. An array 362 for storing the objective function values 148a-148b may be initialized in the step 344 based on the number of particles 252. The array 362 may be a (one)-by-(number of particles) matrix. Data items 363 corresponding to the index i_{particle} from the simulation results files are selected in the step 346. In the step 348, an objective function value (e.g., 148a) may be computed from the selected data. The objective function value 148a is stored in an objective function value array 364 in the step 350. A check is made in the step 352 to determine if each particle has been considered. If more particles may be considered (No), the index i_{particle} may be incremented in the step 354 and the method 320 returns to the select step 346. After each particle has been considered (Yes), the method 340 continues with the step 356.

In the step 356, the particle positions for the current optimization iteration of the number of iterations 268 are stores in a position history matrix 366. The position history matrix 366 may be a (number of design variables)-by-(number of particles)-by-(number of optimization iterations) matrix. The particle objective function values for the current optimization iteration are stored in an objective function history matrix 368 in the step 358. The objective function history matrix 368 is a (number of optimization iterations)-by-(number of particles) matrix. The computation 264 ends in the step 360.

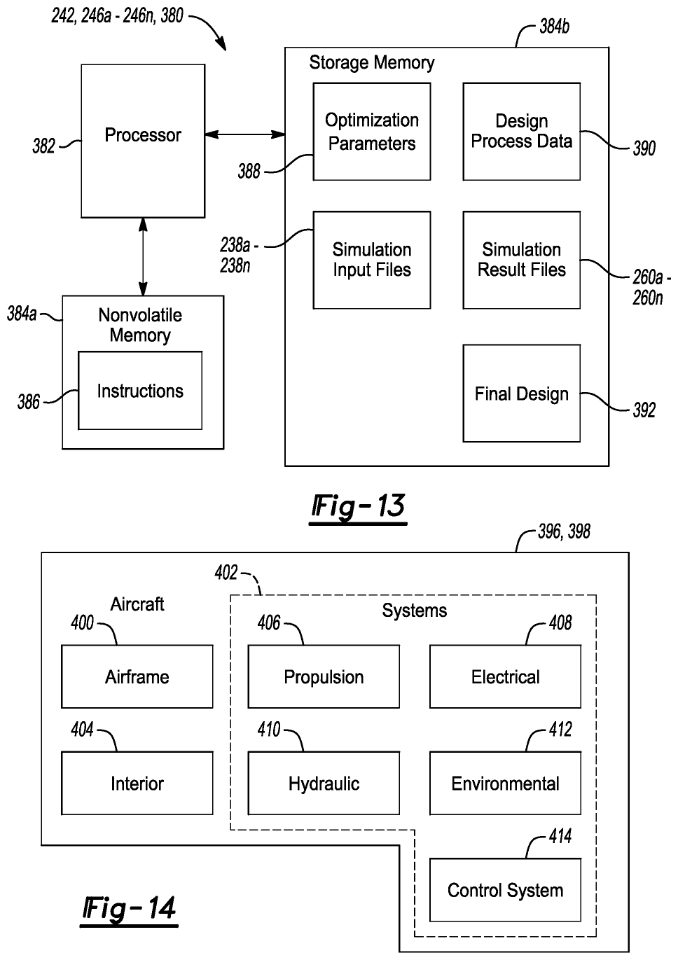

Referring to FIG. 13, with references back to FIGS. 1-9B, a schematic block diagram of an example implementation of a computer 380 is shown in accordance with one or more exemplary embodiments. The computer 380 is representative of the first processor 242 and the simulation processors 246a-246n. Several computers 380 combined are operational to perform the particle swarm optimization 101.

The computer 380 includes one or more processor 382 (one shown) and one or more storage media 384a-384b. A first storage medium (e.g., 384a) may contain one or more instructions 386 (or code or software programs) readable and executable by the processor 382. The first storage medium 384a may be a non-transitory computer readable storage medium. A second storage medium (e.g., 384b) may contain optimization parameters 388, design process data 390, the simulation input files 258a-258n, the simulation result files 260a-260n, and a final design file 392. The second storage medium 384b may be a non-transitory and/or transitory computer readable storage medium.

The instructions 386 control data processing. The instructions 386 may be read and executed by the processor 382 to implement the particle swarm optimization. The files in the second storage medium 384b may be accessed as appropriate during execution. In various embodiments, the instructions 386, the optimization parameters 388, the design process data 390, the simulation input files 258a-258n, the simulation result files 260a-260n, and the final design file 392 may be stored in the same storage medium 384a or 384b.

Referring to FIG. 14, a schematic diagram of example components of a vehicle 396 is shown in accordance with one or more exemplary embodiments. In various embodiments, the vehicle 396 implements an aircraft 398. The aircraft 398 includes an airframe 400 with a plurality of systems 402 and an interior 404. Examples of the systems 402 include one or more of a propulsion system 406, an electrical system 408, a hydraulic system 410, an environmental system 412, and a control system 414. The control system 414 may include control hardware components as actuated by the hydraulic system 410, as well as vehicle control software, that sends commands to the control hardware components. Other numbers of other systems may be included. Although an aerospace example is shown, the principles of the disclosure may be applied to other industries, such as the automotive industry. In various embodiments, the particle swarm optimization 101 may provide the simulation result files from the particles that maximizes the objective function values in order to feed other downstream design calculations for forming one or more parts (or components) of the vehicle 396. In some embodiments, the final design may be a set of simulated inputs from a pilot to achieve a desired outcome.

The system and/or method provided herein provides use of multi-variable optimization to select design criteria and evaluate performance using a high-fidelity engineering simulation. Particle swarm optimization is used for simultaneous optimization of several design criteria and avoids the use of function gradients (e.g., making a better situation for problems of interest that utilize results from an engineering simulation). The setup of such an optimization allows for the usage of high-performance computing assets to run a large portion of the optimization in parallel rather than sequentially, which reduces a specified wall time. The system and/or method also automate complex design iteration loops in a time-efficient manner by selecting optimization parameters allowing optimization to run in parallel.

As explained above and reiterated below, the present disclosure includes, without limitation, the following example implementations.

Clause 1. A method for parallel particle swarm optimization comprising: initializing, with a first processor, a plurality of particle positions of a plurality of particles and a plurality of particle velocities of the plurality of particles in response to a plurality of design variables, wherein the plurality of particles represent a plurality of candidate designs within a solution space; parsing the plurality of particle positions and the plurality of particles velocities into a plurality of simulation input files in a current iteration of a plurality of iterations; presenting the plurality of simulation input files in parallel to a plurality of simulation processors; simulating, with the plurality of simulation processors, the plurality of simulation input files in parallel to produce a plurality of simulation result files; computing a plurality of objective function values of the plurality of particles in response to the plurality of simulation result files; updating the plurality of particles in the solution space using particle swarm optimization based on the plurality of objective function values; and repeating the parsing, the presenting, the simulating, the computing, and the updating in each subsequent iteration of the plurality of iterations to identify a final design.

Clause 2. The method according to clause 1, wherein the updating includes calculating a plurality of particle best positions of the plurality of particles in response to the plurality of objective function values at an end of the current iteration, calculating a global best position of the plurality of particles in response to the plurality of objective function values at the end of the current iteration, and updating the plurality of particles velocities at the end of the current iteration in response to the plurality of particles velocities at a start of the current iteration, the plurality of particle best positions and the global best position.

Clause 3. The method according to clause 2, wherein the updating of the plurality of particles velocities is in further response to a plurality of weights, a plurality of cognitive coefficients, and a plurality of social coefficients that correspond to the plurality of particles.

Clause 4. The method according to clause 2 or clause 3, wherein the updating includes: calculating a plurality of normalized updated particle velocities with respect to a plurality of design variable boundaries at the end of the current iteration; and updating the plurality of particle positions at the end of the current iteration in response to the plurality of particle positions at the start of the current iteration and plurality of normalized updated particle velocities.

Clause 5. The method according to any of clauses 1 to 3, wherein the parsing includes: converting a plurality of design variables into a plurality of simulation variables for a current particle of the plurality of particles; and adding the plurality of simulation variables of the current particle to a simulation runner object array.

Clause 6. The method according to clause 5, wherein the parsing further includes: repeating the converting and the adding for each subsequent particle of the plurality of particles; and separating the simulation runner object array into the plurality of simulation input files after the simulation runner object array is populated.

Clause 7. The method according to any of clauses 1 to 3, wherein the computing includes: selecting from the plurality of simulation result files a plurality of data items that correspond to a current particle of the plurality of particles; computing an objective function value of the current particle in response to the plurality of data items that correspond to the current particle; and storing the objective function value in an objective function value array.

Clause 8. The method according to clause 7, wherein the computing further includes: repeating the selecting and the computing for each subsequent particle of the plurality of particles; and storing the objective function value of each of the plurality of particles in a current iteration in an objective function history matrix.

Clause 9. The method according to any of clauses 1 to 3, wherein the final design feeds one or more downstream calculations that form part of a vehicle.

Clause 10. The method according to any of clauses 1 to 3, wherein the initializing includes: defining a plurality of design variable boundaries; initializing a position matrix of the plurality of particle positions within the plurality of design variable boundaries; defining a plurality of initial velocity bounds; and initializing a velocity matrix of the plurality of particles velocities within the plurality of initial velocity bounds.

Clause 11. A system for parallel particle swarm optimization comprising: a plurality of simulation processors operational to simulate a plurality of simulation input files in parallel to produce a plurality of simulation result files; and a first processor operational to: initialize a plurality of particle positions of a plurality of particles and a plurality of particles velocities of the plurality of particles in response to a plurality of design variables, wherein the plurality of particles represent a plurality of candidate designs within a solution space; parse the plurality of particle positions and the plurality of particles velocities into the plurality of simulation input files in a current iteration of a plurality of iterations; present the plurality of simulation input files in parallel to the plurality of simulation processors; compute a plurality of objective function values of the plurality of particles in response to a plurality of simulation result files; update the plurality of particles in the solution space using particle swarm optimization based on the plurality of objective function values; and repeat the parse, the present, the compute, and the update in each subsequent iteration of the plurality of iterations to identify a final design.

Clause 12. The system according to clause 11, wherein the update includes: calculate a plurality of particle best positions of the plurality of particles in response to the plurality of objective function values at an end of the current iteration; calculate a global best position of the plurality of particles in response to the plurality of objective function values at the end of the current iteration; and update the plurality of particles velocities at the end of the current iteration in response to the plurality of particles velocities at a start of the current iteration, the plurality of particle best positions and the global best position.

Clause 13. The system according to clause 12, wherein the update of the plurality of particles velocities is in further response to a plurality of weights, a plurality of cognitive coefficients, and a plurality of social coefficients that correspond to the plurality of particles.

Clause 14. The system according to clause 12 or clause 13, wherein the update further includes: calculate a plurality of normalized updated particle velocities with respect to a plurality of design variable boundaries at the end of the current iteration; and update the plurality of particle positions at the end of the current iteration in response to the plurality of particle positions at the start of the current iteration and plurality of normalized updated particle velocities.

Clause 15. The system according to any of clauses 11 to 13, wherein the parse includes: convert a plurality of design variables into a plurality of simulation variables for a current particle of the plurality of particles; and add the plurality of simulation variables of the current particle to a simulation runner object array.

Clause 16. The system according to clause 15, wherein the parse further includes: repeat the convert and the add for each subsequent particle of the plurality of particles; and separate the simulation runner object array into the plurality of simulation input files after the simulation runner object array is populated.

Clause 17. The system according to any of clauses 11 to 13, wherein the compute includes: select from the plurality of simulation result files a plurality of data items that correspond to a current particle of the plurality of particles; compute an objective function value of the current particle in response to the plurality of data items that correspond to the current particle; and store the objective function value in an objective function value array.

Clause 18. The system according to clause 17, wherein the compute further includes: repeat the select and the compute for each subsequent particle of the plurality of particles; and store the objective function value of each of the plurality of particles in a current iteration in an objective function history matrix.

Clause 19. The system according to any of clauses 11 to 13, wherein the final design feeds one or more downstream calculations that form part of a vehicle.

Clause 20. A non-transitory computer readable storage medium storing instructions that control data processing, the instructions, when executed by a processor cause the processor to perform a plurality of operations comprising: initializing a plurality of particle positions of a plurality of particles and a plurality of particles velocities of the plurality of particles in response to a plurality of design variables, wherein the plurality of particles represent a plurality of candidate designs within a solution space; parsing the plurality of particle positions and the plurality of particles velocities into a plurality of simulation input files in a current iteration of a plurality of iterations; presenting the plurality of simulation input files in parallel to a plurality of simulation processors, wherein the plurality of simulation processors simulate the plurality of simulation input files in parallel to produce a plurality of simulation result files; computing a plurality of objective function values of the plurality of particles in response to the plurality of simulation result files; updating the plurality of particles in the solution space using particle swarm optimization based on the plurality of objective function values; and repeating the parsing, the presenting, the computing, and the updating in each subsequent iteration of the plurality of iterations to identify a final design.

This disclosure is susceptible of embodiments in many different forms. Representative embodiments of the disclosure are shown in the drawings and are herein described in detail with the understanding that these embodiments are provided as an exemplification of the disclosed principles, not limitations of the broad aspects of the disclosure. To that extent, elements and limitations that are described, for example, in the Abstract, Background, Summary, and Detailed Description sections, but not explicitly set forth in the claims, should not be incorporated into the claims, singly or collectively, by implication, inference or otherwise.

For purposes of the present detailed description, unless specifically disclaimed, the singular includes the plural and vice versa. The words “and” and “of” shall be both conjunctive and disjunctive. The words “any” and “all” shall both mean “any and all”, and the words “including,” “containing,” “comprising,” “having,” and the like shall each mean “including without limitation.” Moreover, words of approximation such as “about,” “almost,” “substantially,” “approximately,” and “generally,” may be used herein in the sense of “at, near, or nearly at,” or “within 0-5% of,” or “within acceptable manufacturing tolerances,” or other logical combinations thereof. Referring to the drawings, wherein like reference numbers refer to like components.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method for parallel particle swarm optimization comprising:
initializing, with a first processor, a plurality of particle positions of a plurality of particles and a plurality of particle velocities of the plurality of particles in response to a plurality of design variables, wherein the plurality of particles represent a plurality of candidate designs within a solution space;
parsing the plurality of particle positions and the plurality of particles velocities into a plurality of simulation input files in a current iteration of a plurality of iterations;
presenting the plurality of simulation input files in parallel to a plurality of simulation processors;
simulating, with the plurality of simulation processors, the plurality of simulation input files in parallel to produce a plurality of simulation result files;
computing a plurality of objective function values of the plurality of particles in response to the plurality of simulation result files;
updating the plurality of particles in the solution space using particle swarm optimization based on the plurality of objective function values; and
repeating the parsing, the presenting, the simulating, the computing, and the updating in each subsequent iteration of the plurality of iterations to identify a final design.

2. The method according to claim 1, wherein the updating includes:
calculating a plurality of particle best positions of the plurality of particles in response to the plurality of objective function values at an end of the current iteration;
calculating a global best position of the plurality of particles in response to the plurality of objective function values at the end of the current iteration; and
updating the plurality of particles velocities at the end of the current iteration in response to the plurality of particles velocities at a start of the current iteration, the plurality of particle best positions and the global best position.

3. The method according to claim 2, wherein the updating of the plurality of particles velocities is in further response to a plurality of weights, a plurality of cognitive coefficients, and a plurality of social coefficients that correspond to the plurality of particles.

4. The method according to claim 2, wherein the updating includes:
calculating a plurality of normalized updated particle velocities with respect to a plurality of design variable boundaries at the end of the current iteration; and
updating the plurality of particle positions at the end of the current iteration in response to the plurality of particle positions at the start of the current iteration and plurality of normalized updated particle velocities.

5. The method according to claim 1, wherein the parsing includes:
converting a plurality of design variables into a plurality of simulation variables for a current particle of the plurality of particles; and
adding the plurality of simulation variables of the current particle to a simulation runner object array.

6. The method according to claim 5, wherein the parsing further includes:
repeating the converting and the adding for each subsequent particle of the plurality of particles; and
separating the simulation runner object array into the plurality of simulation input files after the simulation runner object array is populated.

7. The method according to claim 1, wherein the computing includes:
selecting from the plurality of simulation result files a plurality of data items that correspond to a current particle of the plurality of particles;
computing an objective function value of the current particle in response to the plurality of data items that correspond to the current particle; and
storing the objective function value in an objective function value array.

8. The method according to claim 7, wherein the computing further includes:
repeating the selecting and the computing for each subsequent particle of the plurality of particles; and
storing the objective function value of each of the plurality of particles in a current iteration in an objective function history matrix.

9. The method according to claim 1, wherein the final design feeds one or more downstream calculations that form part of a vehicle.

10. The method according to claim 1, wherein the initializing includes:
defining a plurality of design variable boundaries;
initializing a position matrix of the plurality of particle positions within the plurality of design variable boundaries;
defining a plurality of initial velocity bounds; and
initializing a velocity matrix of the plurality of particles velocities within the plurality of initial velocity bounds.

11. A system for parallel particle swarm optimization comprising:
a plurality of simulation processors operational to simulate a plurality of simulation input files in parallel to produce a plurality of simulation result files; and
a first processor operational to:
initialize a plurality of particle positions of a plurality of particles and a plurality of particles velocities of the plurality of particles in response to a plurality of design variables, wherein the plurality of particles represent a plurality of candidate designs within a solution space;
parse the plurality of particle positions and the plurality of particles velocities into the plurality of simulation input files in a current iteration of a plurality of iterations;
present the plurality of simulation input files in parallel to the plurality of simulation processors;
compute a plurality of objective function values of the plurality of particles in response to a plurality of simulation result files;
update the plurality of particles in the solution space using particle swarm optimization based on the plurality of objective function values; and
repeat the parse, the present, the compute, and the update in each subsequent iteration of the plurality of iterations to identify a final design.

12. The system according to claim 11, wherein the update includes:
calculate a plurality of particle best positions of the plurality of particles in response to the plurality of objective function values at an end of the current iteration;
calculate a global best position of the plurality of particles in response to the plurality of objective function values at the end of the current iteration; and
update the plurality of particles velocities at the end of the current iteration in response to the plurality of particles velocities at a start of the current iteration, the plurality of particle best positions and the global best position.

13. The system according to claim 12, wherein the update of the plurality of particles velocities is in further response to a plurality of weights, a plurality of cognitive coefficients, and a plurality of social coefficients that correspond to the plurality of particles.

14. The system according to claim 12, wherein the update further includes:
calculate a plurality of normalized updated particle velocities with respect to a plurality of design variable boundaries at the end of the current iteration; and
update the plurality of particle positions at the end of the current iteration in response to the plurality of particle positions at the start of the current iteration and plurality of normalized updated particle velocities.

15. The system according to claim 11, wherein the parse includes:
convert a plurality of design variables into a plurality of simulation variables for a current particle of the plurality of particles; and
add the plurality of simulation variables of the current particle to a simulation runner object array.

16. The system according to claim 15, wherein the parse further includes:
repeat the convert and the add for each subsequent particle of the plurality of particles; and
separate the simulation runner object array into the plurality of simulation input files after the simulation runner object array is populated.

17. The system according to claim 11, wherein the compute includes:
select from the plurality of simulation result files a plurality of data items that correspond to a current particle of the plurality of particles;
compute an objective function value of the current particle in response to the plurality of data items that correspond to the current particle; and
store the objective function value in an objective function value array.

18. The system according to claim 17, wherein the compute further includes:
repeat the select and the compute for each subsequent particle of the plurality of particles; and
store the objective function value of each of the plurality of particles in a current iteration in an objective function history matrix.

19. The system according to claim 11, wherein the final design feeds one or more downstream calculations that form part of a vehicle.

20. A non-transitory computer readable storage medium storing instructions that control data processing, the instructions, when executed by a processor cause the processor to perform a plurality of operations comprising:
initializing a plurality of particle positions of a plurality of particles and a plurality of particles velocities of the plurality of particles in response to a plurality of design variables, wherein the plurality of particles represent a plurality of candidate designs within a solution space;
parsing the plurality of particle positions and the plurality of particles velocities into a plurality of simulation input files in a current iteration of a plurality of iterations;
presenting the plurality of simulation input files in parallel to a plurality of simulation processors, wherein the plurality of simulation processors simulate the plurality of simulation input files in parallel to produce a plurality of simulation result files;
computing a plurality of objective function values of the plurality of particles in response to the plurality of simulation result files;
updating the plurality of particles in the solution space using particle swarm optimization based on the plurality of objective function values; and
repeating the parsing, the presenting, the computing, and the updating in each subsequent iteration of the plurality of iterations to identify a final design.
